(19) United States
(12) Patent Application Publication
(10) Pub. No.: US 2020/0020040 A1
(43) Pub. Date: Jan. 16, 2020

(54) SYSTEM AND METHOD FOR EFFICIENT INSURANCE UNDERWRITING

(71) Applicant: Cognizant Technology Solutions India Pvt. Ltd., Chennai (IN)

(72) Inventors: Chandan Gokhale, Alpharetta, GA (US); Sreenivas Rangamani, Iselin, NJ (US)

(21) Appl. No.: 16/123,726

(22) Filed: Sep. 6, 2018

(30) Foreign Application Priority Data
Jul. 12, 2018 (IN) 201841026014

(51) Int. Cl. G06Q 40/08; G06Q 10/10; G06N 5/04

(52) U.S. Cl. CPC G06Q 40/08; G06N 5/04; G06Q 10/10

(57) ABSTRACT

A system and computer-implemented method for efficient insurance underwriting is provided. The system comprises a rule configuration module configured to receive underwriting rules and an applicant information module configured to receive information related to one or more applicants. The system further comprises a data feed module configured to determine presence of a consent form corresponding to each of the one or more applicants. Furthermore, the system comprises a data retrieval and transformation engine configured to retrieve data related to the one or more applicants from one or more sources and transform the retrieved data into a structured and standardized format. The system also comprises an artificial intelligence engine configured to process the transformed data based on the received underwriting rules and a risk computation engine configured to compute a risk score and generate risk information corresponding to each of the one or more applicants.

### FIELD OF THE INVENTION

The present invention relates generally to insurance underwriting. More particularly, the present invention provides a system and method for efficient insurance underwriting in life insurance sector.

### BACKGROUND OF THE INVENTION

Insurance is primarily a risk management business. Efficiently understanding risks associated with issuing policies helps in better pricing of policies, reducing revenue leakage and increasing profitability. Reviewing and assessing medical records and physician statements is critical for determining morbidity and mortality risks associated with issuing life insurance policies. The process of reviewing medical records in the form of attending physician statements (APS) is firmly entrenched in the underwriting practices in the life insurance sectors.

Conventionally, various systems and methods exist for insurance underwriting in life insurance sector. For example, insurance companies use risk management systems that provide a wide range of data including the Attending Physician Statement (APS) and the medical records to the insurance underwriters for assessing risk. However, these existing systems and methods have several manual steps. For instance, documents containing applicant information such as the APS and the medical records are physically copied using copiers and delivered via physical mail or transmitted electronically via email or facsimile. On the receiving side, insurance back office employees or assigned third party employees upload, on the risk management systems, the received information as a scanned image for manual review by the insurance underwriters. Thereafter, the underwriters extract important information and analyze the extracted information based on some standard protocols defined by the insurance company. Sometimes, trained third party employees review the received images and prepare summaries for the underwriters for risk assessment. The underwriters determine insurance premium and risk category based on the analysis and risk assessment conducted by them. However, the above-mentioned systems and methods suffer from several disadvantages. Manually receiving, reviewing and assessing information for risk assessment is prone to human errors. Further, the received information related to the applicant is limited, outdated and prone to manipulation due to manual processes involved thereby hampering accurate risk assessment. Furthermore, there is no consistency in assessment as policy outcome is based on the underwriters' review and discretion. In addition, several weeks (six to eight weeks on an average) are spent waiting for medical records to be sent by physician thereby adding to delays in manual risk assessment. Also, manual risk assessment is expensive due to involvement of numerous personnel.

In light of the above-mentioned disadvantages, there is a need for a system and method for efficient insurance underwriting. Further, there is a need for a system and method that automatically obtains information from multiple sources in real-time for accurate risk assessment. Furthermore, there is a need for a system and method that automatically provides the obtained information in a structured format to the underwriters without any need for manual intervention and assistance. In addition, there is a need for a system and method that is capable of aggregating, analyzing and assessing the obtained information for assisting the insurance underwriters in determining the applicant's risk level.

### SUMMARY OF THE INVENTION

A system, computer-implemented method and computer program product for efficient insurance underwriting is provided. The system comprises a rule configuration module configured to receive one or more underwriting rules. The system further comprises an applicant information module configured to receive information related to one or more applicants. Furthermore, the system comprises a data feed module configured to determine presence of a consent form corresponding to each of the one or more applicants. The system also comprises a data retrieval and transformation engine configured to retrieve data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices and transform the retrieved data into a structured and standardized format. In addition, the system comprises an artificial intelligence engine configured to process the transformed data based on the one or more received underwriting rules. The system further comprises a risk computation engine configured to compute a risk score and generate risk information corresponding to each of the one or more applicants based on the processed data.

In an embodiment of the present invention, the structured and standardized format for transforming the retrieved data comprise JavaScript Object Notation (JSON) format in a Fast Healthcare Interoperability Resources (FHIR) standard and Extensible Markup Language (XML). In an embodiment of the present invention, the transformed data is processed using artificial intelligence and natural language processing techniques. In an embodiment of the present invention, the risk computation engine is further configured to determine high risk conditions and corresponding tags, determine health trends, provide a health summary and provide an underwriting decision corresponding to each of the one or more applicants based on the processed data. In an embodiment of the present invention, the data retrieved from the one or more social media platforms comprise applicants' habits, location data and behavioural data. In an embodiment of the present invention, the system further comprises a social media interface configured to facilitate retrieving data related to the one or more applicants from the one or more social media platforms. Further, the social media interface is a cloud based data mining solution comprising an analytics engine.

The computer-implemented method for efficient insurance underwriting, via program instructions stored in a memory and executed by a processor, comprises receiving one or more underwriting rules and information related to one or more applicants. The computer-implemented method further comprises determining presence of a consent form corresponding to each of the one or more applicants. Furthermore, the computer-implemented method comprises retrieving data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices. The computer-implemented method also comprises transforming the retrieved data into a structured and standardized format. In addition, the computer-implemented method comprises processing the transformed data based on the one or more received underwriting rules. The computer-implemented method further comprises computing a risk score and generating risk information corresponding to each of the one or more applicants based on the processed data.

The computer program product for efficient insurance underwriting comprises a non-transitory computer-readable medium having computer-readable program code stored thereon, the computer-readable program code comprising instructions that when executed by a processor, cause the processor to receive one or more underwriting rules and information related to one or more applicants. The processor further determines presence of a consent form corresponding to each of the one or more applicants. Furthermore, the processor retrieves data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices. The processor also transforms the retrieved data into a structured and standardized format. In addition, the processor processes the transformed data based on the one or more received underwriting rules. The processor further computes a risk score and generates risk information corresponding to each of the one or more applicants based on the processed data.

### BRIEF DESCRIPTION OF THE ACCOMPANYING DRAWINGS

The present invention is described by way of embodiments illustrated in the accompanying drawings wherein:

FIG. 1 is a block diagram illustrating a system for efficient insurance underwriting, in accordance with an embodiment of the present invention;

FIG. 2A and FIG. 2b are flowcharts illustrating a method for efficient insurance underwriting, in accordance with an embodiment of the present invention; and

FIG. 3 illustrates an exemplary computer system for efficient insurance underwriting, in accordance with an embodiment of the present invention.

### DETAILED DESCRIPTION OF THE INVENTION

A system and method for efficient insurance underwriting is described herein. The invention provides a system and method that automatically obtains information from multiple sources in real-time for accurate risk assessment. The invention further provides a system and method that automatically transmits the obtained information in a structured format and provides the same to the underwriters. Furthermore, the invention provides a system and method that is capable of aggregating, analyzing and assessing the obtained information for assisting the insurance underwriters in determining the applicant's risk level. Also, the invention provides a system and method for creating summarized profiles of the applicants that aid in making instant underwriting decisions, determining optimal premium price and reducing revenue leakage.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

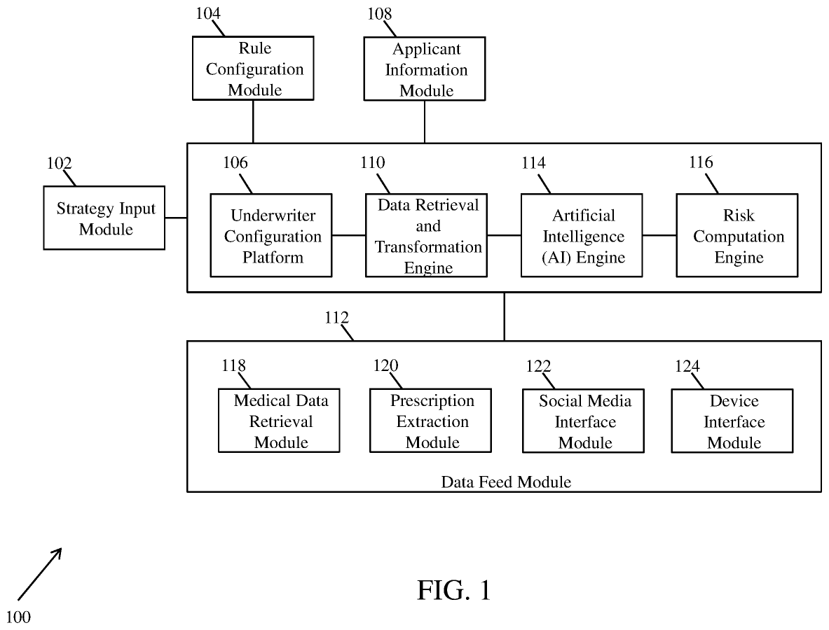

FIG. 1 is a block diagram illustrating a system for efficient insurance underwriting, in accordance with an embodiment of the present invention. The system 100 comprises a strategy input module 102, a rule configuration module 104, an underwriter configuration platform 106, an applicant information module 108, a data retrieval and transformation engine 110 a data feed module 112, an artificial intelligence engine 114 and a risk computation engine 116.

The strategy input module 102 is configured to receive information related to business strategy and risk tolerance from one or more insurance companies. Further, each of the one or more insurance companies have specific business strategy and risk tolerance. For example, an insurance company may offer insurance policies to high risk applicants at a higher insurance premium and another insurance company may not offer insurance to high risk applicants at all. In an embodiment of the present invention, the strategy input module 102 provides a user interface to the one or more insurance companies to provide their business strategy and risk tolerance in the form of one or more configurable business rules. In an embodiment of the present invention, the strategy input module 102 renders a page, via an appropriate electronic communication device connected to the system 100, using which the underwriter configures appropriate risk tolerance levels and provides inputs related to, but not limited to, market and customers.

The rule configuration module 104 is configured to receive one or more underwriting rules. The one or more underwriting rules are used for encoding underwriting protocols and procedures specific to each of the one or more insurance companies. Further, the rule configuration engine 104 provides a user interface for receiving the one or more underwriting rules. In an embodiment of the present invention, the rule configuration module 104 receives insurer specific underwriting manual/guidelines comprising complex rules which are processed and stored as the one or more underwriting rules using a rules engine. In an embodiment of the present invention, Natural Language Processing (NLP) and Artificial Intelligence (AI) is used for configuring the one or more business rules and the one or more underwriting rules by the rules engine. In an exemplary embodiment of the present invention, the one or more underwriting rules include medical underwriting requirements such as, but not limited to, illustrated in table below:

| | | AGES | | | | |
|---|---|---|---|---|---|---|
| | | | Men | Women | | |
| | | | age | age 20 | | |
| | | 19 and | 20 or | or | | |
| | | Younger | older | older | | |
| Cholesterol | Total | <170 | 125-200 | 125-200 | | |
| | | mg/dL | mg/dL | mg/dL | | |
| | LDL | <100 | <100 | <100 | | |
| | | mg/dL | mg/dL | mg/dL | | |
| | HDL | >45 | >40 | >50 | | |
| | | mg/dL | mg/dL | mg/dL | | |
| | | 15-19 | 18-40 | 41-50 | 51-60 | 61+ |
| Blood | | 117/77 | 123/82 | 127/84 | 131/86 | 311/86 |
| Pressure | | | | | | |

In another exemplary embodiment of the present invention, the one or more underwriting rules include medical underwriting requirements such as, but not limited to, illustrated in table below:

| | AGES | | | | |
|---|---|---|---|---|---|
| | | | | | 61 and |
| | 15-17 | 18-40 | 41-50 | 51-60 | over |
| Up | Non- | Non- | Non- | Simple | Simple |
| through | Medical | Medical | Medical | Paramed | Paramed |
| $99,999 | | | | Urine | Urine |
| | | | | Specimen | Specimen |
| $100,000 | Non- | Non- | Simple | Paramed | Paramed |
| through | Medical | Medical | Paramed | Blood | + EKG |
| $249,999 | | Blood | Blood | with | Blood |
| | | with | with | Urine | with |
| | | Urine | Urine | Specimen | Urine |
| | | Specimen | Specimen | | Specimen |
| $250,000 | Non- | Simple | Paramed | Paramed | Paramed |
| through | Medical | Paramed | Blood | + EKG | + EKG |
| $999,999 | | Blood | with | Blood | Blood |
| | | with | Urine | with | with |
| | | Urine | Specimen | Urine | Urine |
| | | Specimen | | Specimen | Specimen |

In an embodiment of the present invention, the system 100 is accessible via one or more electronic communication devices such as, but not limited to, desktops, laptops, tablets and mobile phones. In another embodiment of the present invention, the system 100 is accessible via existing systems such as, but not limited to, insurance management systems employed by the one or more insurance companies. In yet another embodiment of the present invention, the system 100 comprises a display screen for rendering user interfaces provided by various modules of the system 100.

The underwriter configuration platform 106 is configured to communicate with the strategy input module 102 and the rule configuration module 104 for configuring and storing the one or more business rules and the one or more received underwriting rules. The underwriter configuration platform 106 is also configured to provide an underwriter configuration page which is used to receive inputs from the one or more underwriters. Further, the underwriter configuration page provides options to the one or more underwriters to configure appropriate risk tolerance levels and inputs related to, but not limited to, market and customers. Further, the underwriter configuration platform 106 works in conjunction with the strategy input module 102 and the rule configuration module 104.

The applicant information module 108 is configured to receive information related to one or more insurance applicants. The information related to the one or more applicants include, but not limited to, demographic information such as name, date of birth, gender, address etc., consent to retrieve medical information and any other information relevant for risk assessment, identifiable numbers like Social Security Number (SSN), details related to primary care physician such as name and address and any other information from the insurance application that is relevant to obtain medical records. In an embodiment of the present invention, the applicant information module 108 is configured to automatically pull the information related to the one or more insurance applicants from existing systems such as, but not limited to, the insurance companies underwriting systems, business Information Technology (IT) systems and databases. In an embodiment of the present invention, the information related to the one or more insurance applicants is entered/edited by the one or more underwriters via the underwriter configuration platform 108. In an embodiment of the present invention, the applicant information module 108 automatically receives one or more documents comprising the applicant information. Further, the one or more documents are automatically received via one or more channels such as, but not limited to, email, facsimile, instant messengers, insurance company portal/website and any other suitable channel. The applicant information module 108 then extracts relevant information related to the one or more applicants from the submitted documents. In an embodiment of the present invention, the applicant information module 108 uses Natural Language Processing (NLP) for extracting the information related to the one or more applicants. In another embodiment of the present invention, the applicant information module 108 receives information related to the one or more insurance applicants which is extracted by the existing underwriting systems or business databases of the insurer.

The data retrieval and transformation engine 110 is configured to retrieve and transform the retrieved information related to the one or more applicants to a structured format relevant to the insurance industry. The data retrieval and transformation engine 110 is configured to receive input provided by the one or more underwriters via the underwriter configuration platform 106 and based on the received input, query appropriate external sources to retrieve the data related to the applicants. The data retrieval and transformation engine 110 is configured to facilitate retrieving the data from one or more external sources such as, but not limited to, one or more third party medical data sources, one or more health information networks, one or more prescription records databases, one or more patient information systems of hospitals, one or more social media platforms, one or more Internet of Things (IoT) based devices and one or more user devices in conjunction with the data feed module 112. In an embodiment of the present invention, the one or more health information networks is a national level network. The data retrieved by the data retrieval and transformation engine 110 from various sources is then transformed into a structured and standardized format.

In an embodiment of the present invention, the data feed module 112 is configured to determine presence of a consent form corresponding to each of the one or more applicants prior to requesting/retrieving the data from the one or more external sources. The applicant consent form is a statutory requirement for retrieving applicant data during insurance application process.

The data feed module 112 comprises a medical data retrieval module 118, a prescription extraction module 120, a social media interface module 122 and a device interface module 124.

The medical data retrieval module 118 is a gateway to retrieve electronic medical data related to the one or more insurance applicants. The medical data is retrieved from the one or more external sources such, but not limited to, third party medical data sources, a national level health information network and patient information systems employed by various healthcare organizations. In an embodiment of the present invention, the medical records of the one or more applicants are retrieved by the medical data retrieval module 118 using industry standards such as, but not limited to, the standard Cross Community Patient Discovery (XCPD) and the Cross Community Access (XCA) Integrating the Healthcare Enterprise (IHE) profiles or non-standard methods such as, but not limited to, proprietary Extensible Markup Language (XML) schemas.

The prescription extraction module 120 is configured to extract prescription data related to the one or more applicants. In an embodiment of the present invention, the prescription extraction module 120 is a gateway which interacts with databases and systems employed by pharmacies and healthcare organizations for storing information related to prescriptions and usage of medicines.

The social media interface module 122 is a gateway for connecting with and extracting data related to the one or more applicants from one or more social media platforms. The data extracted from the one or more social media platforms include, but not limited to, applicants' habits, location data and behavioral data. In an embodiment of the present invention, the social media interface 122 is a cloud based data mining solution comprising an analytics engine.

The device interface module 124 is a gateway for connecting with and extracting data related to the one or more applicant from one or more IoT based devices and one or more user devices. In an embodiment of the present invention, the one or more user devices include, but not limited to, smartphones, tablets, portable and wearable devices of the one or more applicants. Further, the portable and wearable devices include, but not limited to, fitness bands, smart watches, smart glasses, heart rate monitors, blood pressure monitors and blood sugar monitors. In an embodiment of the present invention, the device interface module 124 extracts data related to the applicant from one or more applications installed on the one or more user devices. In an embodiment of the present invention, the one or more IoT based devices include, but not limited to, devices in an applicant's home connected to a smart home application.

The data retrieval and transformation engine 110 collects the retrieved data related to the one or more applicants from various components of the data feed module 112 and transforms the retrieved data into a structured and standardized form. In an exemplary embodiment of the present invention, the data retrieval and transformation engine 110 comprises a mapping module that selects data relevant for insurance underwriting from the retrieved data related to the one or more applicants. The selected data is then converted to one or more suitable formats compatible with the system 100 and other insurance underwriting systems for further use by other components of the system 100. The one or more suitable formats include, but not limited to, JavaScript Object Notation (JSON) format in a Fast Healthcare Interoperability Resources (FHIR) standard and XML.

Once the data related to the one or more applicants is transformed, the control is transferred to the Artificial Intelligence (AI) engine 114. The AI engine 114 is configured to process the transformed data using artificial intelligence and NLP techniques by analyzing certain free text content and identifying critical risk information corresponding to each of the one or more applicants. Further, the AI engine 114 also considers the one or more business rules and the one or more underwriting rules stored in the underwriter configuration platform 106 for processing the transformed data. Furthermore, the AI engine 114 structures the transformed data and identifies high risk conditions using one or more NLP techniques. The AI engine 114 also prepares a summary corresponding to each of the one or more applicants for use by the one or more underwriters.

The risk computation engine 116 in conjunction with the AI engine 114 is configured to compute a risk score corresponding to each of the one or more applicants, determine high risk conditions and corresponding tags, determine health trends, provide a health summary, compute policy premium and provide an underwriting decision corresponding to each of the one or more applicants based on the processed data. Further, the risk score is generated by the risk computation engine 116 after considering various parameters relevant for making an underwriting decision. The generated risk score aids the underwriters in efficiently assessing the medical profile of the applicant. The output of the risk computation engine 116 is provided to one or more users via the user interface. Further, the one or more users include, but not limited to, insurance underwriters. Furthermore, the output of the risk computation engine 116 guides the insurance underwriters to reach an optimal underwriting decision.

In an embodiment of the present invention, the health summary is provided via a health summary page which comprises applicant details such as name, age and location, applicant health snapshot with brief history, high risk condition tags, health trends and a suggested risk level or risk score or both. In an embodiment of the present invention, the risk computation engine 116 also provides an applicant health details page via the user interface. The health details page provides options to access and view information such as, but not limited to, general health information, health conditions, name and details of healthcare providers, medications, investigation results, vitals, details related to allergies, adverse reactions and alerts, scanned reports and additional notes. In an embodiment of the present invention, the one or more users can also access the extracted medical records, Attending Physician Summary (APS) and physician details. In an embodiment of the present invention, the system 100 also provides information related to the medicines prescribed to the applicant and applicant's adherence to the prescription based on medicine purchase history. In an embodiment of the present invention, the system 100 compares the medications prescribed the physician as determined from the retrieved medical record to the standard prescription feed that is used in the industry. In an embodiment of the present invention, the system 100 determines if the applicant adheres to the prescription based on the information retrieved from one or more applications including, but not limited to, reminder applications and pill/medication tracking applications installed on the one or more user devices.

In an embodiment of the present invention, the system 100 provides data visualization tools for providing the extracted data, the transformed data and the risk assessment data generated by the AI engine 114 and the risk computation engine 116 in various graphical and visual formats for better understanding and aiding in underwriting decision making process.

In an embodiment of the present invention, the system 100 is implemented as a Software-as-a-Service (SaaS) based platform. In another embodiment of the present invention, the system 100 is a data feed based platform.

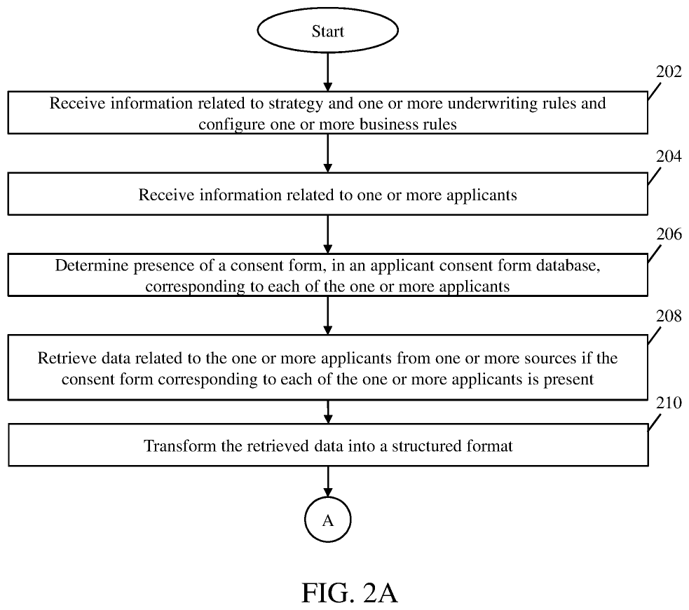

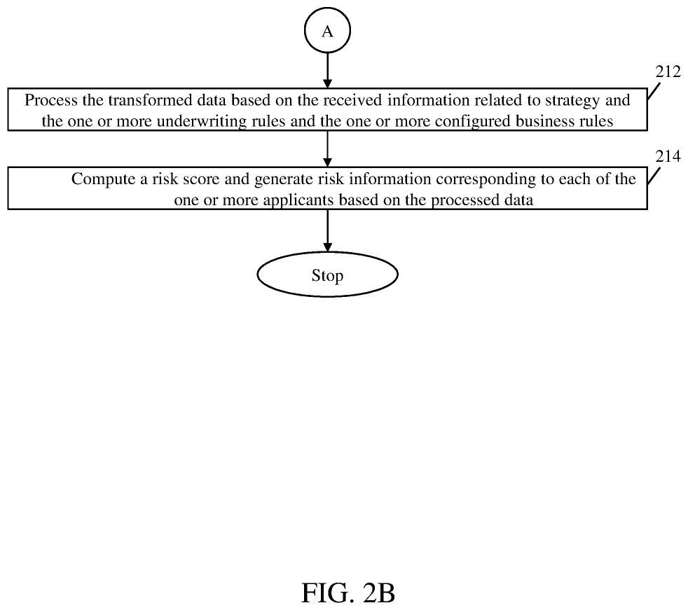

FIG. 2 is a flowchart illustrating a method for efficient insurance underwriting, in accordance with an embodiment of the present invention.

At step 202, information related to strategy and one or more underwriting rules are received and one or more business rules are configured. Further, the information related to the business strategy and risk tolerance is pre-defined by one or more insurance companies. Furthermore, each of the one or more insurance companies have specific business strategy and risk tolerance. For example, an insurance company may offer insurance policies to high risk applicants at a higher insurance premium and another insurance company may not offer insurance to high risk applicants at all. In an embodiment of the present invention, the one or more insurance companies provide their business strategy and risk tolerance in the form of one or more configurable business rules. In an embodiment of the present invention, a page is rendered, via an appropriate electronic communication device, using which one or more underwriters configure appropriate risk tolerance levels and provide input related to, but not limited to, market and customers. In an embodiment of the present invention, the one or more underwriting rules are received and the one or more business rules are configured via the user interface.

The one or more underwriting rules are used for encoding underwriting protocols and procedures specific to each of the one or more insurance companies. In an embodiment of the present invention, insurer specific underwriting manual/guidelines comprising complex rules are received, processed and stored as the one or more underwriting rules using a rules engine. In an embodiment of the present invention, Natural Language Processing (NLP) and Artificial Intelligence (AI) is used for configuring the one or more business rules and the one or more underwriting rules by the rules engine. In an exemplary embodiment of the present invention, the one or more underwriting rules include medical underwriting requirements such as, but not limited to, illustrated in table below:

| | | AGES | | | | |
|---|---|---|---|---|---|---|
| | | | Men | Women | | |
| | | | age | age 20 | | |
| | | 19 and | 20 or | or | | |
| | | Younger | older | older | | |
| Cholesterol | Total | <170 | 125-200 | 125-200 | | |
| | | mg/dL | mg/dL | mg/dL | | |
| | LDL | <100 | <100 | <100 | | |
| | | mg/dL | mg/dL | mg/dL | | |
| | HDL | >45 | >40 | >50 | | |
| | | mg/dL | mg/dL | mg/dL | | |
| | | 15-19 | 18-40 | 41-50 | 51-60 | 60+ |
| Blood | | 117/77 | 123/82 | 127/84 | 131/86 | 311/86 |
| Pressure | | | | | | |

In another exemplary embodiment of the present invention, the one or more underwriting rules include medical underwriting requirements such as, but not limited to, illustrated in table below:

| | AGES | | | | |
|---|---|---|---|---|---|
| | | | | | 61 and |
| | 15-17 | 18-40 | 41-50 | 51-60 | over |
| Up | Non- | Non- | Non- | Simple | Simple |
| through | Medical | Medical | Medical | Paramed | Paramed |
| $99,999 | | | | Urine | Urine |
| | | | | Specimen | Specimen |
| $100,000 | Non- | Non- | Simple | Paramed | Paramed |
| through | Medical | Medical | Paramed | Blood | + EKG |
| $249,999 | | Blood | Blood | with | Blood |
| | | with | with | Urine | with |
| | | Urine | Urine | Specimen | Urine |
| | | Specimen | Specimen | | Specimen |
| $250,000 | Non- | Simple | Paramed | Paramed | Paramed |
| through | Medical | Paramed | Blood | + EKG | + EKG |
| $999,999 | | Blood | with | Blood | Blood |
| | | with | Urine | with | with |
| | | Urine | Specimen | Urine | Urine |
| | | Specimen | | Specimen | Specimen |

In an embodiment of the present invention, the user interface is accessible via one or more electronic communication devices such as, but not limited to, desktops, laptops, tablets and mobile phones. In another embodiment of the present invention, the user interface is provided via existing systems such as, but not limited to, insurance management systems employed by the one or more insurance companies.

At step 204, information related to one or more insurance applicants is received. The information related to the one or more applicants include, but not limited to, demographic information such as name, date of birth, gender, address etc., consent to retrieve medical information and any other information relevant for risk assessment, identifiable numbers like Social Security Number (SSN), details related to primary care physician such as name and address and any other information from the insurance application that is relevant to obtain medical records. In an embodiment of the present invention, the information related to the one or more insurance applicants is automatically pulled from existing systems such as, but not limited to, the insurance companies underwriting systems, business Information Technology (IT) systems and databases. In an embodiment of the present invention, the information related to the one or more insurance applicants is entered/edited by the one or more underwriters via an underwriter configuration platform. In an embodiment of the present invention, one or more documents comprising the applicant information are automatically received via one or more channels such as, but not limited to, email, facsimile, instant messengers, insurance company portal/website and any other suitable channel. Further, relevant information related to the one or more applicants is then retrieved from the received documents. In an embodiment of the present invention, Natural Language Processing (NLP) is used for retrieving the information related to the one or more applicants. In another embodiment of the present invention, the information related to the one or more insurance applicants is retrieved by the existing underwriting systems or business databases of the insurer and provided for further processing.

At step 206, presence of a consent form, in an applicant consent form database, corresponding to each of the one or more applicants is determined.

At step 208, data related to the one or more applicants is retrieved from one or more sources if the consent form corresponding to each of the one or more applicants is present. In an embodiment of the present invention, on receiving input from the one or more underwriters, the one or more external sources are queried to retrieve the data related to the one or more applicants. The one or more external sources include, but not limited to, one or more third party medical data sources, one or more health information networks, one or more prescription records databases, one or more patient information systems of hospitals, one or more social media platforms, one or more Internet of Things (IoT) based devices and one or more user devices. In an embodiment of the present invention, the one or more health information networks is a national level network.

At step 210, the retrieved data from the one or more sources is transformed into a structured and standardized format. The structured and standardized format for transforming the retrieved data include, but not limited to, JavaScript Object Notation (JSON) format in a Fast Healthcare Interoperability Resources (FHIR) standard and Extensible Markup Language (XML).

At step 212, the transformed data is processed based on the received information related to strategy and the one or more underwriting rules and the one or more configured business rules. The transformed data related to the one or more applicants is processed using artificial intelligence and NLP techniques by analyzing certain free text content and identifying critical risk information corresponding to each of the one or more applicants based on the one or more business rules and the one or more underwriting rules.

At step 214, a risk score is computed and risk information is generated corresponding to each of the one or more applicants based on the processed data. In an embodiment of the present invention, high risk conditions are identified using the NLP techniques. Further, a risk summary corresponding to each of the one or more applicants is also generated for use by the one or more underwriters based on the processed data.

In an embodiment of the present invention, a risk computation engine in conjunction with an artificial intelligence engine is used to compute the risk score corresponding to each of the one or more applicants, determine high risk conditions and corresponding tags, determine health trends, provide a health summary, compute policy premium and provide an underwriting decision corresponding to each of the one or more applicants based on the processed data. Further, the risk score is generated after considering various parameters relevant for making an underwriting decision. The generated risk score aids the underwriters in efficiently assessing medical profile of the applicant.

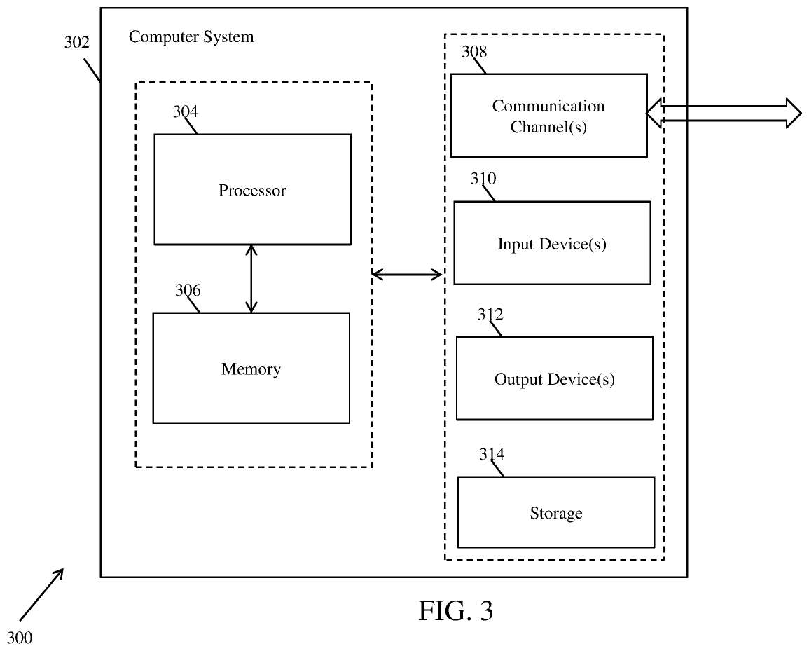

FIG. 3 illustrates an exemplary computer system for efficient insurance underwriting, in accordance with an embodiment of the present invention.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for efficient insurance underwriting, the system comprising:
a rule configuration module configured to receive one or more underwriting rules;
an applicant information module configured to receive information related to one or more applicants;
a data feed module configured to determine presence of a consent form corresponding to each of the one or more applicants;
a data retrieval and transformation engine configured to:
retrieve data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices; and
transform the retrieved data into a structured and standardized format;
an artificial intelligence engine configured to process the transformed data based on the one or more received underwriting rules; and
a risk computation engine configured to compute a risk score and generate risk information corresponding to each of the one or more applicants based on the processed data.

2. The system of claim 1, wherein the structured and standardized format for transforming the retrieved data comprise JavaScript Object Notation (JSON) format in a Fast Healthcare Interoperability Resources (FHIR) standard and Extensible Markup Language (XML).

3. The system of claim 1, wherein the transformed data is processed using artificial intelligence and natural language processing techniques.

4. The system of claim 1, wherein the risk computation engine is further configured to determine high risk conditions and corresponding tags, determine health trends, provide a health summary and provide an underwriting decision corresponding to each of the one or more applicants based on the processed data.

5. The system of claim 1, wherein the data retrieved from the one or more social media platforms comprise applicants' habits, location data and behavioural data.

6. The system of claim 1 further comprising a social media interface configured to facilitate retrieving data related to the one or more applicants from the one or more social media platforms.

7. The system of claim 6, wherein the social media interface is a cloud based data mining solution comprising an analytics engine.

8. A computer-implemented method for efficient insurance underwriting, via program instructions stored in a memory and executed by a processor, the computer-implemented method comprising:
receiving one or more underwriting rules and information related to one or more applicants;
determining presence of a consent form corresponding to each of the one or more applicants;
retrieving data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices;
transforming the retrieved data into a structured and standardized format;
processing the transformed data based on the one or more received underwriting rules; and
computing a risk score and generating risk information corresponding to each of the one or more applicants based on the processed data.

9. The computer-implemented method of claim 8, wherein the structured and standardized format for transforming the retrieved data comprise JavaScript Object Notation (JSON) format in a Fast Healthcare Interoperability Resources (FHIR) standard and Extensible Markup Language (XML).

10. The computer-implemented method of claim 8, wherein the transformed data is processed using artificial intelligence and natural language processing techniques.

11. The computer-implemented method of claim 8 further comprising determining high risk conditions and corresponding tags, determining health trends, providing a health summary and providing an underwriting decision corresponding to each of the one or more applicants based on the processed data.

12. The computer-implemented method of claim 8, wherein the data retrieved from the one or more social media platforms comprise applicants' habits, location data and behavioural data.

13. A computer program product for efficient insurance underwriting, the computer program product comprising:
a non-transitory computer-readable medium having computer-readable program code stored thereon, the computer-readable program code comprising instructions that when executed by a processor, cause the processor to:
receive one or more underwriting rules and information related to one or more applicants;
determine presence of a consent form corresponding to each of the one or more applicants;
retrieve data related to the one or more applicants from one or more sources if the consent form corresponding to each of the one or more applicants is present, wherein the data related to the one or more applicants is retrieved from one or more external sources comprising one or more third party medical data sources, one or more health information networks, one or more prescription records databases, one or more patient information systems of hospitals, one or more social media platforms, one or more Internet of Things (IoT) based devices and one or more user devices;
transform the retrieved data into a structured and standardized format;
process the transformed data based on the one or more received underwriting rules; and
compute a risk score and generate risk information corresponding to each of the one or more applicants based on the processed data.
